(19) United States
(12) Patent Application Publication
(10) Pub. No.: US 2026/0198648 A1
(43) Pub. Date: Jul. 16, 2026

(54) CUSHIONING ELEMENT FOR A SHOE COMPRISING A SPIRAL GRID STRUCTURE

(71) Applicant: adidas AG, Herzogenaurach (DE)

(72) Inventors: Meng ZHAO, Herzogenaurach (DE); Raphael CURET, Nuremberg (DE); Andrew GORDON, Nuremberg (DE); Shadi Habibi PARSA, Erlangen (DE); Aleksandr SMYSLOV, Nuremberg (DE)

(21) Appl. No.: 19/441,524

(22) Filed: Jan. 6, 2026

(30) Foreign Application Priority Data
Jan. 15, 2025 (DE) 10 2025 101 301.2

(51) Int. Cl. A43B 13/18

(52) U.S. Cl. CPC A43B 13/184

(57) ABSTRACT

The present disclosure relates to cushioning element adapted to be arranged at a sole plate of a shoe, such as a football shoe. The cushioning element comprises a grid structure arranged in a spiral pattern. The present disclosure also relates to a sole plate adapted to be arranged at a shoe and a shoe comprising the sole plate and the cushioning element.

### CROSS REFERENCE TO RELATED APPLICATIONS

This application claims priority to German Patent Application No. 10 2025 101 301.2, filed January 15, 2025, which is incorporated by reference herein in its entirety.

### TECHNICAL FIELD

Some embodiments of the present disclosure relates to a cushioning element adapted to be arranged at a sole plate of a shoe. The sole plate may comprise a grid structure, wherein the grid structure may be arranged in a spiral pattern. Some embodiments of the present disclosure are directed to a sole plate adapted to be arranged at a shoe and a shoe comprising the sole plate and a cushioning element.

### BACKGROUND

Aiming to maximize the performance of an athlete is at the very heart of the development and evolution of sporting goods. This especially applies to sport shoes, e.g., running shoes and/or football shoes, where the performance of the athlete crucially depends on the performance of the shoe. Therefore, a lot of effort has been made to optimize the performance of sport shoes, particularly running and/or football shoes.

Specifically, the optimization of the performance of sport shoes, particularly football shoes, is mostly directed to the needs of male athletes, focusing on their specific physiology and their specific biomechanics. However, there are several differences between male and female athletes, particularly with respect to specific movements that appear in football, e.g., internal lateral movements and/or twisting movements. These differences comprise anatomic differences, such as the shape of the foot, differences in biomechanics, as well as differences with respect to injury patterns. For example, women are more prone to certain injuries compared to their male counterparts. Specifically, female footballers suffer more often from anterior cruciate ligament injuries.

However, these differences have not been directly addressed so far. In fact, despite the increasing popularity and success of women’s football, the women’s football shoes are often unisex and/or scaled-down versions of the corresponding men’s football shoes. Such unisex and/or scaled-down versions of the corresponding men’s football shoes do not properly capture the anatomic and biomechanical specifics of women and fail to adequately support female athletes.

Therefore, there is a need for an improved sports shoe, such as a football shoe, that is adapted to the specific needs of female footballers, addressing at least some of the above-described disadvantages.

### BRIEF SUMMARY

The present disclosure is directed to a cushioning element for a sole plate of a shoe. The cushioning element may comprise one or more grid structures that emanate in a spiral pattern. In some embodiments, the one or more grid structures may emanate from an origin of the grid structure, where the origin may comprise an aperture.

A first embodiment (I) of the present disclosure is directed to a cushioning element adapted to be arranged at a sole plate of a shoe, comprising a grid structure, wherein the grid structure is arranged in a spiral pattern.

In a second embodiment (II), in the cushioning element of the first embodiment (I), at least a part of the grid structure emanates in the spiral pattern from an origin of the grid structure.

In a third embodiment (III), in the cushioning element of the second embodiment (II), the origin comprises an aperture, and the aperture comprises a circular or elliptic geometry.

In a fourth embodiment (IV), in the cushioning element of the third embodiment (III), a diameter of the aperture is at least 0.5 cm; and/or at most 5 cm.

In a fifth embodiment (V), in the cushioning element of any one of embodiments (III)-(IV), the origin of the grid structure is arranged in a forefoot region of the cushioning element and is: adapted to receive a medial portion of a foot; and/or adapted to receive a central portion of a foot.

In a sixth embodiment (VI), in the cushioning element of any one of embodiments (I)-(V), the grid structure comprises a plurality of grid elements, wherein the plurality of grid elements is arranged such as to at least partially form the spiral pattern of the grid structure.

In a seventh embodiment (VII), in the cushioning element any one of embodiments (II)-(VI), at least one grid element of the plurality of grid elements emanates from the origin of the grid structure.

In an eighth embodiment (VIII), in the cushioning element of any one of embodiments (VI)-(VII), a first grid element of the plurality of grid elements intersects at least a second grid element of the plurality of grid elements.

In a ninth embodiment (IX), in the cushioning element of the eighth embodiment (VIII), the first grid element intersects the second grid element essentially perpendicularly.

In a tenth embodiment (X), in the cushioning element of any one of embodiments (VI)-(IX), a thickness of the plurality of grid elements is: at least 0.1 mm; and at most 2 cm.

In an eleventh embodiment (XI), the cushioning element of any one of embodiments (I)-(X) further comprises a continuous portion, wherein at least a part of the continuous portion is located at a boundary of the cushioning element.

In a twelfth embodiment (XII), in the cushioning element of the eleventh embodiment (XI), the continuous portion essentially follows the boundary of the cushioning element such as to essentially encompass the complete boundary of the cushioning element.

In a thirteenth embodiment (XIII), in the cushioning element of any one of embodiments (XI)-(XII), a diameter of the continuous portion is: at least 0.1 cm; and at most 6 cm.

In a fourteenth embodiment (XIV), in the cushioning element of any one of embodiments (I)-(XIII), a shape and/or size of the cushioning element is based on a shape and/or size of a portion of the sole plate.

In a fifteenth embodiment (XV), in the cushioning element of any one of embodiments (I)-(XIV), at least a part of the cushioning element is 3D printed.

In a sixteenth embodiment (XVI), in the cushioning element of the fifteenth embodiment (XV), at least a part of the cushioning element that is 3D printed is 3D printed by stereolithography.

In a seventeenth embodiment (XVII), in the cushioning element of any one of embodiments (I)-(XVI), the cushioning element comprises polyurethane.

In an eighteenth embodiment (XVIII), in the cushioning element of any one of embodiments (I)-(XVII), the grid structure covers: at least 10% of the cushioning element; and at most 99% of the cushioning element.

In a nineteenth embodiment (XIX), the cushioning element of any one of embodiments (I)-(XVIII) further comprises at least one sidewall, wherein the at least one sidewall is arranged at a boundary of the cushioning element and extends from the continuous portion of the cushioning element.

A twentieth embodiment (XX) of the present disclosure is directed to a sole plate adapted to be arranged at a shoe, the sole plate comprising: a first cavity adapted to receive a first cushioning element of any one of embodiments (I)-(XIX).

In a twenty-first embodiment (XXI), in the sole plate of the twentieth embodiment (XX), the first cavity is arranged in a region of the sole plate adapted to receive a forefoot and/or a midfoot and extends from the region adapted to receive the forefoot to the region adapted to receive the midfoot.

In a twenty-second embodiment (XXII), in the sole plate of the twenty-first embodiment (XXI), a diameter of the first cavity is based on a diameter of the sole plate.

In a twenty-third embodiment (XXIII), in the sole plate of any one of embodiments (XX)-(XXII), the first cavity is arranged on a side of the sole plate adapted to face a foot.

In a twenty-fourth embodiment (XXIV), in the sole plate of any one of embodiments (XX)-(XXIII), at least a part of the sole plate is manufactured by injection molding.

In a twenty-fifth embodiment (XXV), in the sole plate of any one of embodiments (XX)-(XXIV), the sole plate comprises polyamide.

In a twenty-sixth embodiment (XXVI), in the sole plate of any one of embodiments (XX)-(XXV), the sole plate comprises a second grid structure; and wherein the second grid structure comprises a spiral and/or rectangular pattern.

In a twenty-seventh embodiment (XXVII), in the sole plate of the twenty-sixth embodiment (XXVI), the second grid structure is arranged at a heel area of the sole plate.

In a twenty-eighth embodiment (XXVIII), in the sole plate of any one of embodiments (XXVI)-(XXVII), at least a portion of the second grid structure is integrally formed with the sole plate.

In a twenty-ninth embodiment (XXIX), the sole plate of any one of embodiments (XX)-(XXVIII) comprises a first cushioning element according to any one of embodiments (I)-(XIX).

A thirtieth embodiment (XXX) of the present disclosure is directed to a shoe comprising a sole plate of any one of embodiments (XX)-(XXVIII); and a cushioning element of any one of embodiments (I)-(XIX), wherein the cushioning element is arranged in a cavity of the sole plate.

In a thirty-first embodiment, in the shoe of the thirtieth embodiment (XXX), at least a part of the inner sole is arranged on the cushioning element.

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the present disclosure is generally described in the context of these embodiments, it should be understood that it is not intended to limit the scope of the present disclosure to these particular embodiments. In the drawings, like reference numbers indicate identical or functionally similar elements.

In the following, exemplary embodiments of the disclosure are described with reference to the figures. The figures show:

FIG. 1 shows a top view of a cushioning element arranged at a sole plate, according to some embodiments.

FIG. 2A shows a lateral top side view of a sole plate, wherein a cushioning element is arranged at the sole plate, according to some embodiments.

FIG. 2B shows a top side view of the sole plate of FIG. 2A, according to some embodiments.

FIG. 2C shows a lateral top side view of the sole plate of FIG. 2A, wherein a cushioning element is not yet arranged at the sole plate, according to some embodiments.

FIG. 2D shows a bottom side view of the sole plate of FIG. 2A, according to some embodiments.

FIG. 3 shows a cushioning plate according to some embodiments

### DETAILED DESCRIPTION

In the following, only some possible embodiments of the disclosure are described in detail. It is to be understood that these embodiments can be modified in a number of ways and combined with each other whenever compatible and that certain features may be omitted in so far as they appear dispensable.

In some embodiments of the present disclosure, a cushioning element may be adapted to be arranged at a sole plate of a shoe, e.g., at a sole plate of a football shoe. The cushioning element may comprise a grid structure. Specifically, the grid structure may be arranged in a spiral pattern.

A cushioning element adapted to be arranged at a sole plate of a shoe, e.g., a sole plate of a football shoe, may comprise that the cushioning element may be arranged at an inner side of the sole plate. An inner side of the sole plate may comprise a side of the sole plate adapted to face a foot. Specifically, a cushioning element adapted to be arranged at a sole plate may comprise that the cushioning element is adapted to be inlayed in the sole plate. In other words, the cushioning element may be adapted to be placed at an inner side of the sole plate.

In some embodiments, the cushioning element may comprise a grid structure. A grid structure may comprise regions without material, e.g., the grid structure may comprise at least one hole and/or slot. For example, the grid structure of the cushioning element may comprise a mesh. The grid structure may be an integral part of the cushioning element.

The grid structure may be arranged in a spiral pattern. For example, the grid structure may be arranged such as to form a spiral pattern. Arranging the grid structure in a spiral pattern may comprise that the grid structure comprises at least one spiral pattern. In other words, the spiral pattern may comprise a pattern that winds around a center point at an increasing or decreasing, e.g., continuously increasing or continuously decreasing, distance from the center point. Specifically, the spiral pattern may comprise a structure emanating from the center point and moving further away as it revolves around the center point. In some embodiments, the grid structure may comprise a plurality of spiral patterns. In some embodiments, the grid structure may comprise a section of a spiral pattern. A section of a spiral pattern, may comprise a portion of the grid structure that follows the spiral pattern, e.g., follows the spiral pattern without comprising a complete spiral. A portion of the grid structure following the spiral pattern without comprising the complete spiral may comprise that the portion of the grid structure following the spiral pattern does not comprise the center point of the corresponding spiral.

In some embodiments, a cushioning element comprising a grid structure, wherein the grid structure may be arranged in a spiral pattern, may facilitate rotational movements that are performed by an athlete wearing a shoe comprising the cushioning element. Specifically, a grid structure arranged in a spiral pattern allows for mitigating excessive torsional resistance during twisting movements. Facilitating rotational movements and/or mitigating excessive torsional resistance during twisting movements may reduce or minimize an injury risk, e.g., a risk for anterior cruciate ligament injuries, and may optimize the performance of the athlete.

Moreover, a cushioning element with a grid structure according to embodiments disclosed herein may allow for a weight reduction of the cushioning element, as the grid structure may comprise holes and/or notches. By reducing the weight of the cushioning element, the weight of the corresponding shoe, e.g., a football shoe, can be reduced. Reducing the weight of the corresponding shoe may optimize the performance and the wearing comfort of the athlete.

In some embodiments, at least a part of the grid structure may emanate in the spiral pattern from an origin of the grid structure.

For example, the grid structure may comprise an origin. The origin of the grid structure may be at least partially comprised in the grid structure. Alternatively, the origin may comprise a point outside of the grid structure, e.g., a hypothetical point. Specifically, the spiral pattern may emanate from the origin of the grid structure. For example, a spiral of the spiral pattern may emanate from the origin of the grid structure. In some embodiments, the spiral pattern may comprise more than one spiral (e.g., spirals, a plurality of spirals, etc.). In some embodiments, the spirals of the spiral pattern may emanate from the origin of the grid structure, e.g., the spirals of the spiral pattern may originate from a common point. For example, the spirals of the spiral pattern may emanate from the origin of the grid structure and move further away from the origin the spirals revolve around the origin. In other words, the spirals of the spiral pattern may wind around the origin at a continuously increasing or decreasing distance from the origin.

In some embodiments, a cushioning element with a grid structure, wherein at least a part of the grid structure emanates in the spiral pattern from an origin of the grid structure, may enhance the stability of the grid structure. In addition, the origin of the spiral pattern may serve as a pivot point during twisting movements and/or internal lateral movements, thereby mitigating excessive torsional resistance, therefore contributing to a reduced joint strain without impairing the performance of the athlete. In some embodiments, a position of the origin of the grid structure can be changed based on the needs of the athlete. For example, changing the origin of the grid structure, e.g., changing the position of the origin, may change a pivot point of the cushioning element and/or the shoe comprising the cushioning element and thus may enable the adaptation of the pivot point to the particular needs of an athlete.

In some embodiments, the origin of the grid structure may comprise an aperture. For example, the aperture may comprise a circular geometry. In addition, or alternatively, the aperture may comprise an elliptic geometry.

In some embodiments, the aperture may comprise a region of the grid structure without material. For example, the aperture may comprise a circle geometry and/or an elliptic geometry. For example, the elliptic geometry may comprise a minor semi-axis and a major semi-axis. In some embodiments, when the aperture comprises an elliptic geometry, the major semi-axis may be essentially parallel to a longitudinal direction of the cushioning element. Being essentially parallel may comprise that the major semi-axis of the elliptic geometry and the longitudinal direction form an angle of at most 20°, at most 15°, at most 10°, at most 5°, or at most 3°. The longitudinal direction of the cushioning element may correspond to a longitudinal direction of a shoe comprising the cushioning element. In addition, or alternatively, the aperture may comprise a polygonal geometry, e.g., the aperture may comprise a triangle geometry.

An origin of the grid structure comprising an aperture contributes to a weight reduction of the cushioning element and thereby to a weight reduction of the shoe comprising the cushioning element. A weight reduction of the shoe, e.g., a football shoe, may minimize the weight of the shoe and may optimize the performance of the athlete.

In some embodiments, a diameter of the aperture may be at least 0.5 cm. In some embodiments, the diameter of the aperture may be at least 1 cm. In some embodiments, the diameter of the aperture may be at least 1.5 cm. In some embodiments, the diameter of the aperture may be at least 2 cm. In some embodiments, the diameter of the aperture may be at most 5 cm. In some embodiments, the diameter of the aperture may be at most 4 cm. In some embodiments, the diameter of the aperture may be at most 3 cm. In some embodiments, the diameter of the aperture may be at most 4 cm. In some embodiments, the diameter of the aperture may be at most 5 cm. In some embodiments, the diameter of the aperture may be at most 6 cm. In some embodiments, the diameter of the aperture may be at most 7 cm. In some embodiments, the diameter of the aperture may be in the range between 0.6 cm and 1 cm (inclusive), or in the range between 0.7 cm and 0.9 cm (inclusive.

The diameter of the aperture may be based on the geometry of the aperture. For example, an aperture comprising a circle geometry may be associated with a different diameter than the aperture comprising an elliptic geometry. In particular, a diameter of a circle may comprise a radius and/or a diameter of the circle. In addition, or alternatively, a diameter of an ellipse may be based on a length of the semi-minor axis and/or the semi-major axis. In addition, or alternatively, a diameter of a triangle may be based on a height of the triangle and/or a radius of a circle encompassing the triangle.

In some embodiments, a diameter of the aperture of at least 0.5 cm contributes to the weight reduction of the cushioning element and thus to the weight reduction of a shoe comprising the cushioning element. Moreover, an aperture with a diameter of at least 0.5 cm may ensure that a circumference of the aperture is sufficiently large such that the aperture can serve as an origin of the grid structure, e.g., such that sufficiently many spirals of the spiral pattern can emanate from the aperture.

A diameter of the aperture of at most 7 cm may ensure that the cushioning element is sufficiently stable, e.g., stable such as to resist a force exerted by an athlete.

In addition, or alternatively, the diameter of the aperture may be based on a length and/or a width and/or a thickness of the cushioning element. In addition, or alternatively, the diameter of the aperture may be based the position of the aperture, e.g., the position of the aperture within and/or with respect to the grid structure. For example, the diameter of the aperture may be in the range between 5% and 95% of the length of the cushioning element, in the range between 10% and 90% of the length of the cushioning element, in the range between 15% and 85% of the length of the cushioning element, or in the range between 20% and 80% of the length of the cushioning element. Specifically, when the aperture comprises an elliptic and/or oval geometry, the diameter of the aperture may be based on the width of the cushioning element. In particular, the diameter of the aperture may be in the range between 5% and 95% of the width of the cushioning element, in the range between 10% and 90% of the width of the cushioning element, in the range between 15% and 85% of the width of the cushioning element, or in the range between 20% and 80% of the width of the cushioning element.

Adapting the diameter of the aperture to the dimension of the cushioning element, e.g., the length and/or the width and/or the thickness of the cushioning element, and/or to the position of the aperture provides tunability and adjustability of the aperture to the specific properties of a cushioning element. Specifically, adapting the diameter of the aperture to the dimension of the cushioning element, e.g., the length and/or the width and/or the thickness of the cushioning element, and/or to the position of the aperture allows for tuning and/or adjusting the aperture to different sizes, e.g., shoe sizes, of the cushioning element.

In some embodiments, the origin of the grid structure may be arranged in a region of the cushioning element adapted to receive a medial portion of a foot. For example, the origin of the grid structure may be arranged in a region of the cushioning element adapted to receive a medial portion of a forefoot. In some embodiments, the origin of the grid structure may be arranged in a region of the cushioning element adapted to receive a medial portion of a midfoot.

In some embodiments, the origin of the grid structure may be arranged in a region of the cushioning element adapted to receive a central portion of a foot. For example, the origin of the grid structure may be arranged in a region of the cushioning element adapted to receive a central forefoot portion. In some embodiments, the origin of the grid structure may be arranged in a region of the cushioning element adapted to receive a central midfoot portion.

Arranging the origin of the grid structure in a region of the cushioning element adapted to receive a medial and/or central portion of a foot may refer to a region of the cushioning element that receives a medial and/or central portion of a foot when arranged in a corresponding shoe.

The arrangement of the origin of the grid structure in a region of the cushioning element adapted to receive a medial and/or central portion of a foot may contribute to an improved load distribution and a reduced joint strain. In particular, a grid structure comprising a spiral pattern arranged in a region of the cushioning element adapted to receive a medial and/or central portion of a forefoot may facilitate rotational movements as the pivot point of the athlete is typically located in the medial and/or central forefoot portion, e.g., the athlete rests his/her weight on the forefoot portion during rotational movements.

In some embodiments, the grid structure may comprise a plurality of grid elements. For example, the plurality of grid elements may be arranged such as to at least partially form the spiral pattern of the grid structure.

In some embodiments, the grid elements of the grid structure may form the grid structure. For example, the grid structure may comprise a first grid element and a second grid element. At least a portion of the first grid element may be separated from the second grid element, e.g., the portion of the first grid element may be distant to the second grid element. In particular, the first grid element and the second grid element may be separated such as to form a hole and/or a notch between the first grid element and the second grid element. Generally, the grid elements may comprise a shape of a line and/or path. For example, the first grid element may comprise the shape of a first line and/or path and the second grid element may comprise the shape of a second line and/or path. In some embodiments, the grid structure may comprise at least three grid elements, at least five grid elements, at least seven grid elements, at least nine grid elements, or at least 12 grid elements.

In some embodiments, the plurality of grid elements may be arranged such as to at least partially form the spiral pattern of the grid structure. For example, at least one grid element of the plurality of grid elements may comprise a spiral, e.g., the at least one grid element may follow a spiral pattern. A grid element following a spiral pattern may comprise that the grid element emanates from a point (e.g., an origin) and moves further away from the point as it revolves around the point. In other words, the grid element may wind around a point at a continuously increasing or decreasing distance from the point.

A grid structure comprising a plurality of grid elements that is arranged such as to at least partially form the spiral pattern of the grid structure may allow for a formation of the grid structure that is arranged in a spiral pattern. Therefore, a grid structure comprising a plurality of grid elements may contribute to the mitigation of torsional resistance during twisting movements and may facilitate rotational movements

In some embodiments, at least one of the grid elements of the plurality of grid elements may emanate from the origin of the grid structure.

For example, the plurality of grid elements may emanate from the aperture of the origin of the grid structure. In particular, a start point of a grid element of the plurality of grid elements may be located in a vicinity of the origin and/or the aperture. Specifically, the start points of grid elements of the plurality of grid elements may be arranged along a boundary of the aperture. In an example embodiment, the start points of the grid elements of the plurality of grid elements may be arranged along a boundary of the aperture such that the start points are equally distributed along the boundary of the aperture, e.g., a distance between the start points of the grid elements may be equal. In another example embodiment, the start points of the grid elements of the plurality of grid elements may be arranged along the boundary of the aperture such that the start points are not equally distributed along the boundary of the aperture, e.g., a distance between the start points of the grid elements may not be equal.

In some embodiments, a first grid element of the plurality of grid elements may intersect at least one second grid element of the plurality of grid elements.

For example, first grid element may be arranged such as to intersect at least a portion of the second grid element. Specifically, the first grid element may emanate from the origin of the grid structure such as to intersect the at least portion of the second grid element. Generally, the first grid element may intersect the second grid element and may continue to emanate after the intersection, e.g., emanating in a spiral pattern.

In some embodiments, the plurality of grid elements may comprise two groups of grid elements. For example, a first group of grid elements may be arranged in a first spiral pattern and a second group of grid elements may be arranged in a second spiral pattern. For example, the first spiral pattern may comprise a spiral pattern associated with a first orientation. Specifically, the first orientation may comprise a clockwise orientation, e.g., clockwise with respect to the origin of the spiral pattern. In particular, the grid elements of the first group of grid elements may emanate from the origin of the spiral pattern according to the first orientation. For example, the grid elements of the first group may emanate from the origin of the spiral pattern such as to emanate in a clockwise orientation. In other words, a grid element of the first group of grid elements may wind in a clockwise direction around the origin of the spiral pattern at an increasing or decreasing distance from the origin of the spiral pattern.

In addition, or alternatively, the second spiral pattern may comprise a spiral pattern associated with a second orientation. Specifically, the second orientation may comprise a counterclockwise orientation, e.g., counterclockwise with respect to the origin of the spiral pattern. In particular, the grid elements of the second group may emanate from the origin of the spiral pattern according to the second orientation. For example, the grid elements of the second group may emanate from the origin of the spiral pattern such as to emanate in a counterclockwise orientation. In other words, a grid element of the second group of grid elements may wind in a counterclockwise direction around the origin of the spiral pattern at an increasing or decreasing distance from the origin of the spiral pattern.

In some embodiments, the grid elements of the first group may be arranged such as to not intersect grid elements of the first group. In addition, or alternatively, the grid elements of the second group may be arranged such as to not intersect grid elements of the second group. In other words, grid elements emanating from the origin in the same orientation may not intersect each other. A grid element of the first group may intersect at least one grid element of the second group. In addition, or alternatively, a grid element of the second group may intersect at least one grid element of the first group. In other words, grid elements that emanate from the origin of the grid structure in different orientations may intersect each other.

In some embodiments, a first grid element may a second grid element essentially perpendicularly. Intersecting the second grid element essentially perpendicularly may comprise that the first grid element intersects the second grid element with an angle in the range between 60° and 120°, in the range between 70° and 110°, in the range between 80° and 100°, or in the range between 85° and 95°. For example, the first grid element may be a grid element of the first group of grid elements and the second grid element may be a grid element of the second group of grid elements.

In some embodiments, a thickness of the plurality of grid elements may be at least 0.1 mm. In some embodiments, the thickness of the plurality of grid elements may be at least 0.5 mm. In some embodiments, the thickness of the plurality of grid elements may be at least 0.9 mm. In some embodiments, the thickness of the plurality of grid elements may be at least 1.3 mm. In some embodiments, the thickness of the plurality of grid elements may be at least 1.7 mm. In some embodiments, the thickness of the plurality of grid elements may be at most 2 cm. In some embodiments, the thickness of the plurality of grid elements may be at most 1.5 cm. In some embodiments, the thickness of the plurality of grid elements may be at most 1.0 cm. In some embodiments, the thickness of the plurality of grid elements may be at most 0.5 cm. In some embodiments, the thickness of the plurality of grid elements may be at most 2.5 mm.

In some embodiments, the plurality of grid elements may comprise a diameter of a grid element with respect to a cross-section. Specifically, the cross-section may be essentially perpendicular to the direction of emanation of the grid element, e.g., the direction of the spiral. In some embodiments, the thickness of a grid element may be based on a size, e.g., a length and/or a width, and/or a geometry of the cushioning element. Specifically, the thickness of a grid element may be based on a size, e.g., a length and/or a width, and/or a geometry of the grid structure of the cushioning element. For example, the thickness of the grid element may be larger for a larger size of the cushioning element and/or a larger size of the grid structure.

In addition, or alternatively, the thickness of the plurality of grid elements may be based on a number of grid elements comprised in the plurality of grid elements. For example, the thickness of the grid elements may be such that the grid structure can comprise at least three grid elements, at least five grid elements, at least seven grid elements, at least nine grid elements, or at least 12 grid elements. In other words, the thickness of the grid elements may decrease with an increasing number of grid elements in the plurality of grid elements.

In some embodiments, grid elements with a thickness of at least 0.1 mm may ensure that the cushioning element, particularly the grid structure, is sufficiently stable, e.g., stable such as to resist a force exerted by an athlete. In addition, a thickness of the grid element of at most 0.5 cm may allow for reducing the weight of the cushioning element and thereby of a shoe comprising the cushioning element. Reducing the weight of a shoe may optimize the performance of an athlete.

In some embodiments, the cushioning element may further comprise a continuous portion. In particular, at least a part of the continuous portion may be located at a boundary of the cushioning element.

In some embodiments, the continuous portion of the cushioning element may comprise a portion of continuous material. For example, the continuous portion may not comprise a hole and/or notches. Specifically, the continuous portion may not comprise the grid structure. In addition, or alternatively, the continuous portion may be adapted such as to form essentially a smooth surface. In some embodiments, the continuous portion may be a monobloc, e.g., the continuous portion may be formed as one piece. In addition, or alternatively, the continuous portion may comprise a plurality of continuous portions, e.g., the plurality of continuous portions may be separate portions. Two continuous portions may be separate when they are not connected by a continuous portion. For example, the two continuous portions may be separated by a portion of the grid structure.

In some embodiments, the boundary of the cushioning element may comprise an outer boundary of the cushioning element, e.g., a boundary that encompasses the cushioning element from the outside. At least a part of the continuous portion may be located at the boundary of the cushioning element. For example, a boundary of the part of the continuous portion may be located in a vicinity of the boundary of the cushioning element. In particular, the boundary of the part of the continuous portion may form a part of the boundary of the cushioning element.

In some embodiments, a first part of the continuous portion may be located at the boundary of the cushioning element. In addition, a second part of the continuous portion may be located at a distance to the boundary of the cushioning element. For example, the first part of the continuous portion may comprise a front end of the continuous portion. In addition, or alternatively, the first part of the continuous portion may comprise a rear end of the continuous portion. In other words, the front end and/or the rear end of the continuous portion may be located at a boundary of the cushioning element. For example, a part of the front end and/or the rear end of the continuous portion may form a part of the boundary of the cushioning element. The second part of the continuous portion may comprise a lateral and/or medial part of the continuous portion. Specifically, the second part of the continuous portion may be distant to the boundary of the cushioning element such that between the second part of the continuous portion and the outer surface a portion of the grid structure extends. In other words, between a boundary of the second part of the continuous portion and the boundary of the cushioning element a portion of the grid structure may extend, e.g., the portion of the grid structure may connect the second part of the continuous portion and the boundary of the cushioning element.

Locating at least a part of the continuous portion at the boundary of the cushioning element may contribute to the stability of the grid structure and thereby to the stability of the cushioning element. Specifically, locating the part of the continuous portion at the boundary of the cushioning element allows for joining grid elements, e.g., end points of the grid elements, with the continuous portion.

For example, the at least part of the continuous portion may essentially follow the boundary of the cushioning element. In particular, the continuous portion may essentially follow the boundary of the cushioning element such as to essentially encompass the complete boundary of the cushioning element.

In some embodiments, the at least part of the continuous portion that is arranged at the boundary of the cushioning element may essentially follow the boundary of the cushioning element. Essentially following the boundary of the cushioning element may comprise that a curvature and/or a shape of the boundary of the at least part of the continuous portion follows a curvature and/or a shape of the boundary of the cushioning element. Specifically, the continuous portion may essentially follow the boundary of the cushioning element such as to essentially encompass the complete boundary of the cushioning element. For example, the continuous portion may be arranged at the boundary of the cushioning element along the complete boundary of the cushioning element. In particular, the continuous portion may be arranged at the boundary of the cushioning element such as to form the boundary of the cushioning element.

In some embodiments, a diameter of the continuous portion of the cushioning element may be at least 0.1 cm. In some embodiments, the diameter of the continuous portion of the cushioning element may be at least 0.5 cm. In some embodiments, the diameter of the continuous portion of the cushioning element may be at least 0.9 cm. In some embodiments, the diameter of the continuous portion of the cushioning element may be at least 1.4 cm. In some embodiments, the diameter of the continuous portion of the cushioning element may be at least 2 cm. In some embodiments, the diameter of the continuous portion of the cushioning element may be at most 6 cm. In some embodiments, the diameter of the continuous portion of the cushioning element may be at most 5 cm. In some embodiments, the diameter of the continuous portion of the cushioning element may be at most 4 cm. In some embodiments, the diameter of the continuous portion of the cushioning element may be at most 3 cm. In some embodiments, the diameter of the continuous portion of the cushioning element may be at most 2 cm.

In some embodiments, the diameter of the continuous portion may comprise an extension of the continuous portion with respect to a direction pointing from a boundary of the cushioning element towards an inner portion of the cushioning element. In some embodiments, the diameter of the continuous portion may vary along the continuous portion. For example, a first part of the continuous portion may comprise a first diameter and a second part of the continuous portion may comprise a second diameter. In addition, or alternatively, the diameter of the continuous portion may vary continuously along the continuous portion. In some embodiments, the diameter of the continuous portion may be essentially constant along the continuous portion. An essentially constant diameter of the continuous portion may comprise that the diameter of the continuous portion varies by at most 30%, at most 20%, at most 10 at most 5%, or at most 2%.

In addition, or alternatively, the diameter of the continuous portion may be based on a size, e.g., a length and/or a width, and/or a geometry of the cushioning element. In addition, or alternatively, the diameter of the continuous portion may be based on a position of the origin of the grid structure, such as a position and/or a size of the aperture of the cushioning element.

In some embodiments, a shape of the cushioning element may be based on a shape and/or size of the sole plate. In addition, or alternatively, a size of the cushioning element may be based on the shape and/or size of the sole plate.

For example, the shape of the cushioning element may be such that the cushioning element can be arranged at the sole plate. For example, the cushioning element may essentially comprise the shape and/or size of a portion of the sole plate. Specifically, the shape of the cushioning element may essentially comprise the shape and/or size of a forefoot and/or midfoot portion of the sole plate. Comprising essentially the same shape as the sole plate may comprise that at least a portion of a boundary of the cushioning element follows the boundary of the sole plate. In particular, a curvature of the at least a portion of the boundary of the cushioning element may follow a curvature of the boundary of the sole plate. In addition, or alternatively, the size of the cushioning element may be such that the cushioning element can be arranged at the sole plate.

A size and/or shape of the cushioning element based on the size and/or shape of the sole plate may allow for arranging the cushioning element at the sole plate and may enable the sole plate to receive the cushioning element. In particular, a size and/or a shape of the cushioning element that essentially comprises a size and/or shape of the sole plate may ensure that the cushioning element provides its advantageous effects at a maximal region and also may ensure that the cushioning element does not get out of place, e.g., the cushioning element cannot shift during movements of the shoe comprising the sole plate.

In some embodiments, at least a part of the cushioning element may be 3D printed. For example, the at least part of the cushioning element that is 3D printed may comprise the grid structure. In addition, or alternatively, the at least part of the cushioning element that is 3D printed may comprise the continuous portion.

For example, the grid structure of the cushioning element may be 3D printed. 3D printing the grid structure of the cushioning element may comprise 3D printing the grid elements of the grid structure. In particular, the grid structure, e.g., the grid elements of the grid structure, may be 3D printed such as to follow a spiral pattern. In some embodiments, the grid structure and the continuous portion of the cushioning element may be 3D printed. Specifically, the grid structure and the continuous portion of the cushioning element may be 3D printed such as to form one piece.

3D printing the grid structure and/or the continuous portion of the cushioning element may simplify and facilitate the production of the cushioning element, thereby minimizing the production costs and optimizing the production process. In addition, 3D printing the grid structure and/or the continuous portion of the cushioning element may ensure a consistent quality of the cushioning element, e.g., the grid structure of the cushioning element can be consistently reproduced.

Specifically, the at least a part of the cushioning element that is 3D printed may be 3D printed by stereolithography. For example, the at least a part of the cushioning element that is 3D printed may be 3D printed based on a photochemical process.

For example, the 3D printing process may be based on photochemical techniques. In addition, or alternatively, the 3D printing process may be based on powder 3D printing techniques. In addition, or alternatively, the 3D printing process may be based on filament 3D printing techniques. For example, the powder- and/or filament 3D printing techniques may be based on elastic, e.g., non-thermal, materials.

Using photochemical techniques may allow for providing homogeneous properties across different printing directions. Providing homogeneous properties across different printing directions may minimize spatial variations of the properties of the cushioning element, thereby optimizing the quality of the cushioning element.

In some embodiments, the cushioning element may comprise polyurethane. For example, the grid structure of the cushioning element may comprise polyurethane.

For example, the grid elements of the grid structure may comprise polyurethane. In addition, or alternatively, the continuous portion of the cushioning element may comprise polyurethane. In addition, or alternatively, the cushioning element, e.g., the grid structure and/or the continuous portion, may comprise thermoplastic elastomers. For example, thermoplastic elastomers may comprise thermoplastic polyamides (TPE-A) and/or thermoplastic copolyesters (TPE-E) and/or thermoplastic polyurethane (TPU).

In some embodiments, the grid structure may cover at least 10% of the cushioning element. In some embodiments, the grid structure may cover at least 30% of the cushioning element. In some embodiments, the grid structure may cover at least 50% of the cushioning element. In some embodiments, the grid structure may cover at least 70% of the cushioning element. In some embodiments, the grid structure may cover at least 90% of the cushioning element.

A grid structure covering the cushioning element may comprise that the grid structure forms the cushioning element, e.g., covering at least 10% of the cushioning element may comprise that at least 10% of the cushioning element is formed by the grid structure. In some embodiments, the amount of the cushioning element that is covered by the grid structure may be based on a size of the continuous portion. For example, the size, e.g., the diameter, of the continuous portion may decrease when the area covered by the grid structure increases. In some embodiments, the size of the continuous portion may be complementary to the area covered by the grid structure. For example, the area of the grid structure and the size, e.g., the area, of the continuous portion may be such that their union essentially corresponds to the area of the cushioning element. For example, when the grid structure of the cushioning element covers X% of the cushioning element, the size, e.g., the diameter, of the continuous portion may be configured such that the continuous portion covers an area of 100% - X% of the cushioning element.

A grid structure covering at least 10% of the cushioning element may ensure that the spiral pattern of the grid structure covers at least 10% of the cushioning element. Covering at least 10% of the cushioning element with the spiral pattern may facilitate rotational movements of the athlete as it may guarantee a sufficiently large area of a lower side of a foot of the athlete contacts and/or faces the spiral pattern.

In some embodiments, the grid structure may cover at most 99% of the cushioning element. In some embodiments, the grid structure may cover at most 95% of the cushioning element. In some embodiments, the grid structure may cover at most 90% of the cushioning element. In some embodiments, the grid structure may cover at most 85% of the cushioning element. In some embodiments, the grid structure may cover at most 80% of the cushioning element.

Covering at most 99% of the cushioning element with the grid structure ensures that a sufficiently large part, e.g., at least 1% of the cushioning element, is covered by the continuous portion. Covering a sufficiently large area of the cushioning element, e.g., at least 1%, with the continuous portion contributes to the stability of the cushioning element.

In some embodiments, the cushioning element may further comprise at least one sidewall. For example, the at least one sidewall may be arranged at a boundary of the cushioning element. In particular, the at least one sidewall of the cushioning element may extend from the continuous portion of the cushioning element.

In some embodiments, the sidewall of the cushioning element may comprise an increase in a vertical extension of the cushioning element. Specifically, the cushioning element may comprise an increase in the vertical extension of the cushioning element at a boundary region of the cushioning element. For example, the sidewall may emerge from the continuous portion of the cushioning element. Specifically, the sidewall may emerge from the continuous portion of the cushioning element such that the sidewall bends the continuous portion upwards. In other words, the sidewall may comprise an upwardly bended part of the continuous portion. Specifically, the sidewall may be such that a thickness of the continuous portion does essentially not increase at the location of the sidewall. In addition, or alternatively, the sidewall may comprise a portion of the cushioning element comprising additional material, e.g., a thickness of the sidewall may be larger than a thickness of the continuous portion.

A sidewall of the cushioning element may contribute to the stability of the cushioning element, particularly to the stability of the continuous portion. In addition, the sidewall may enable and facilitate the arrangement of the cushioning element at the sole plate. In particular, the sidewall may be adapted such that a shape and/or geometry of the sidewall follows a shape and/or geometry of a portion of the sole element, e.g., a portion of the sole element adapted to receive the cushioning element.

In some embodiments of the present disclosure a sole plate may be adapted to be arranged at a shoe, e.g., a football shoe. The sole plate may comprise a first cavity adapted to receive a first cushioning element. The first cushioning element may comprise an above-described cushioning element.

In some embodiments, the first cavity of the sole plate may comprise a region that is adapted to receive the first cushioning element. Specifically, a size and/or shape of the cavity may be such as to enable the cavity to receive the cushioning element. Generally, a portion of the sole plate may be formed and/or shaped such that the portion of the sole plate essentially forms the first cavity. For example, the first cavity of the sole plate may be essentially formed by a surface of the sole plate. In other words, the first cavity may be an integral part of the sole plate. For example, a size and/or shape of the first cavity may be such that the first cavity and the cushioning element form a positive locking when the first cavity receives the cushioning element. Generally, receiving the cushioning element by the first cavity may comprise arranging the cushioning element at a sole plate.

For example, the first cavity may be arranged in a region of the sole plate adapted to receive a forefoot. In addition, or alternatively, the first cavity may be arranged in a region of the sole plate adapted to receive a midfoot. In particular, the cavity may extend from the region adapted to receive the forefoot to the region adapted to receive the midfoot.

For example, a portion of the sole element may be formed and/or shaped such that the first cavity is arranged in a region adapted to receive a forefoot. In addition, or alternatively, a portion of the sole element may be formed and/or shaped such that the first cavity is arranged in a region adapted to receive a midfoot. In some embodiments, the first cavity may extend from the region adapted to receive the forefoot to the region adapted to receive a midfoot. For example, the first cavity may extend to the region adapted to receive a midfoot such as to essentially cover the complete midfoot region. Covering essentially the complete midfoot region may comprise that the first cavity extends to a rear end of the midfoot portion, e.g., to a point where the region adapted to receive the midfoot transitions into a region adapted to receive a rearfoot and/or a heel.

In some embodiments, a diameter of the cavity may be based on a diameter of the sole plate. For example, the diameter of the cavity may essentially correspond to the diameter of the sole plate.

In some embodiments, the diameter of the sole plate may comprise a diameter of the sole plate with respect to a direction pointing from a medial side of the sole plate to a lateral side of the sole plate. Generally, the diameter of the sole plate may vary along a length of the sole plate. For example, the diameter of the sole plate may continuously vary along the sole plate. In particular, the diameter of the sole plate in the region adapted to receive the midfoot may be smaller than a diameter of the sole plate in a region adapted to receive a forefoot and/or a rearfoot. Similarly, the diameter of the first cavity may vary along a length of the first cavity. For example, the diameter of the first cavity may vary along the length of the sole plate such as to correspond to the diameter variation of the sole plate. Specifically, the diameter of the first cavity may essentially correspond to the diameter of the sole plate. Essentially corresponding to the diameter of the sole plate may comprise that the diameter of the cavity deviates by at most 20%, at most 15%, at most 10%, at most 5%, or at most 2% from the diameter of the sole plate.

Specifically, the cavity may be arranged on a side of the sole plate adapted to face a foot. In other words, the cavity may not be arranged on a side of the sole plate adapted to face a ground.

In some embodiments, at least a part of the sole plate may be manufactured by injection molding. For example, the complete sole plate may be manufactured by injection molding. In some embodiments, the sole plate may comprise polyamide. For example, the sole plate may comprise polyamide 11.

In some embodiments, the sole plate may comprise a second grid structure. For example, the second grid structure may comprise a spiral pattern.

In some embodiments, the second grid structure may comprise a spiral pattern, e.g., the second grid structure may comprise a plurality of grid elements following a spiral pattern. In addition, or alternatively, the second grid structure may comprise a rectangular and/or quadratic and/or rhombic pattern. For example, the grid elements of the second grid structure may be arranged in a rectangular and/or quadratic pattern. Specifically, the grid elements of the second grid structure may be arranged such as to form rectangular and/or quadratic and/or rhombic holes and/or notches. Specifically, the plurality of grid elements of the second grid structure may be arranged such that the size of the rectangular and/or quadratic and/or rhombic holes and/or notches varies with the position of the respective hole and/or notch. For example, a first hole and/or notch at a first position may comprise a first size and the second hole and/or notch at a second position may comprise a second size. For example, a hole and/or a notch arranged at a rearfoot portion of the sole plate may be larger than a hole and/or a notch arranged at a midfoot portion. In addition, or alternatively, at least a part of the grid elements of the plurality of grid elements of the second grid structure may comprise essentially the same size and/or shape.

In some embodiments, the second grid structure of the sole plate may provide further cushioning of the sole plate and thus of the shoe, thereby optimizing the wearing comfort and the performance of the athlete. In addition, the second grid structure of the sole plate may reduce the weight of the sole plate, thereby reducing the weight of the shoe comprising the sole plate.

In some embodiments, the second grid structure may be arranged at a heel area of the sole plate. In addition, or alternatively, the second grid structure may be arranged at a portion of the sole plate adapted to receive a midfoot. Specifically, the second grid structure may extend from the heel area of the sole plate towards the midfoot portion of the sole plate. In addition, or alternatively, at least a part of the second grid structure may be arranged at a portion of the sole plate adapted to receive a forefoot. For example, an area of the second grid structure may cover at least 10%, at least 30%, at least 50 at least 70%, or at least 90% of the heel area of the sole plate.

In some embodiments, at least a portion of the second grid structure may be integrally formed with the sole plate. For example, the at least portion of the second grid structure may be integrally formed with the sole plate by injection molding. In addition, or alternatively, at least a portion of the second grid structure may be attached to the sole plate. For example, the at least a portion of the grid structure may be attached to the sole plate via gluing. In some embodiments, the second grid structure may cover a connected area of the sole plate, e.g., the second grid structure may not comprise at least two unconnected second grid structures. In some embodiments, the second grid structure may split in a region of the sole plate adapted to receive a midfoot.

In some embodiments, the sole plate may comprise at least one stud. The at least one stud may be arranged on a side of the sole plate adapted to face a ground. In other words, the at least one stud may be arranged on a side of the sole plate opposite to the side of the sole plate comprising the cavity. For example, the at least one stud may be arranged in a region adapted to receive a forefoot. In addition, or alternatively, the at least one stud may be arranged in a region adapted to receive a midfoot. In addition, or alternatively, the at least one stud may be arranged in a region adapted to receive a rearfoot. For example, the sole element may comprise at least two, at least three, or at least four studs. In some embodiments, at least two studs, at least three studs, or at least four studs may be arranged at portion of the sole plate adapted to receive a rearfoot.

In some embodiments, the at least one stud may be arranged at a medial side of the sole plate. Specifically, the at least one stud may be arranged at a medial boundary of the sole plate. In addition, or alternatively, the at least one stud may be arranged at the lateral side of the sole plate. Specifically, the at least one stud may be arranged at a lateral boundary of the sole plate. In addition, or alternatively, the at least one stud may be arranged at a central portion of the sole plate, e.g., a portion where the medial side of the sole plate transitions into the lateral side of the sole plate. For example, the at least one stud may be arranged at a forefoot central portion of the sole element. In some embodiments, the number of studs at the lateral side may be based on the number of studs at the medial side of the sole plate. For example, the number of studs at the lateral side may be equal to the number of studs at the medial side of the sole plate. In some embodiments, the studs may be an integral part of the sole plate. For example, the studs and the sole plate may be formed as one piece. In some embodiments, the studs may be formed by molding, e.g., injection molding. In some embodiments, the studs may be formed by 3D printing.

In some embodiments, the above-described sole plate may comprise the above-described first cushioning element.

Some embodiments of the present disclosure relate to a shoe, e.g., a football shoe. The shoe may comprise the above-described sole element. In addition, the shoe may comprise the above-described cushioning element. Specifically, the cushioning element may be arranged in a cavity of the sole element.

In some embodiments, the shoe may further comprise an inner sole. For example, at least a part of the inner sole may be arranged on the cushioning element.

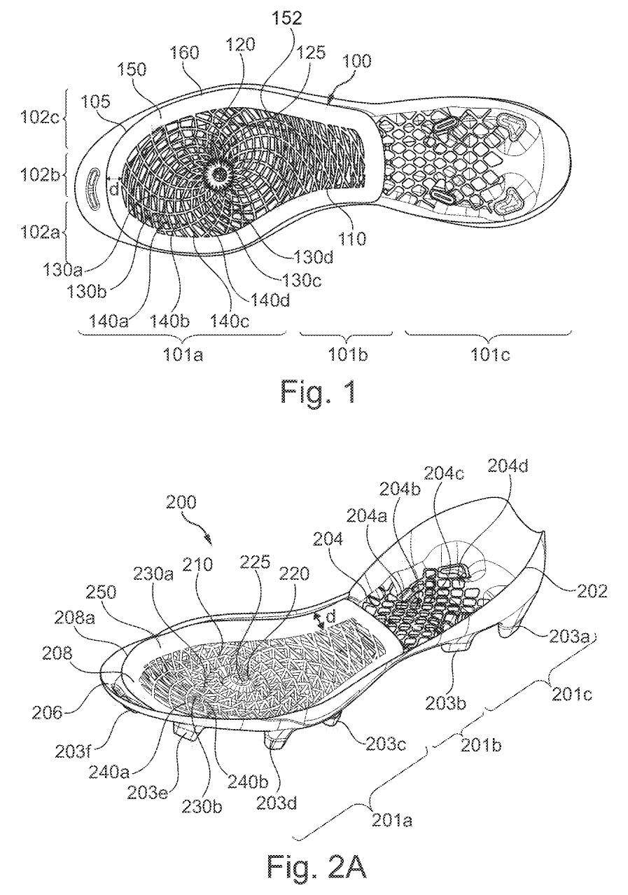

FIG. 1 shows an exemplary embodiment of a cushioning element 100 arranged at a sole plate. The cushioning element 100 comprises a grid structure 110. In some embodiments, the grid structure 110 may be arranged in a spiral pattern. In some embodiments, the cushioning element 100 may comprise an origin 120. At least a part of the grid structure 110 may emanate from the origin 120 in the spiral pattern. In some embodiments, the origin 120 may comprise an aperture 125. In some embodiments, the aperture 125 may comprise a circle geometry, e.g., the aperture 125 of the origin 120 may have the form of a circle. In some embodiments, the aperture 125 of the origin 120 may comprise a different geometry, e.g., an elliptic and/or polygonal geometry. In some embodiments, the origin 120, and particularly the aperture 125 of the origin 120, may be located in a central region 102b of a forefoot region 101a. For example, the origin 120 and/or the aperture 125 of the origin 120 may be arranged essentially symmetrical with respect to the cushioning element 100. In some embodiments, the origin 120 and the aperture 125 may be concentric. In some embodiments, the origin 120 and the aperture 125 may not be concentric.

In some embodiments, the grid structure 110 may comprise a plurality of grid elements. For example, the grid structure 110 may comprise the grid elements 130a, 130b, 130c, 130d, 140a, 140b, 140c, 140d. The grid elements 130a, 130b, 130c, 130d, 140a, 140b, 140c, 140d may be arranged such as to form the spiral pattern of the grid structure 110. In particular, the grid elements 130a, 130b, 130c, 130d, 140a, 140b, 140c, 140d may essentially follow the shape of a spiral. At least a part of the grid elements 130a, 130b, 130c, 130d, 140a, 140b, 140c, 140d of the grid structure 110 may emanate from the origin 120, particularly from the aperture 125 of the origin 120. In particular, the grid elements 130a, 130b, 130c, 130d, 140a, 140b, 140c, 140d may emanate from the origin 120 of the grid structure 110. In some embodiments, the grid elements 130a, 130b, 130c, 130d, 140a, 140b, 140c, 140d essentially follow the shape of the spiral emanating from the origin 120 and move further away from the origin 120 as they revolve around the origin 120. In other words, each grid element 130a, 130b, 130c, 130d, 140a, 140b, 140c, 140d corresponds to a curve that winds around the origin 120 at an increasing or decreasing distance from the origin 120. In some embodiments, the grid structure 110 may comprise a first group of grid elements (e.g., the grid elements 130a, 130b, 130c, 130d) and a second group of grid elements (e.g., the grid elements 140a, 140b, 140c, 140d). Specifically, the first group of grid elements may be arranged such as to comprise a clockwise orientation. For example, each of the grid elements 130a, 130b, 130c, 130d of the first group of grid elements may wind around the origin 120 in a clockwise direction. In some embodiments, the second group of grid elements may be arranged such as to comprise a counterclockwise orientation. For example, each of the grid elements 140a, 140b, 140c, 140d of the second group of grid elements may wind around the origin 120 in a counterclockwise direction.

In some embodiments, at least some of the grid elements 130a, 130b, 130c, 130d, 140a, 140b, 140c, 140d of the grid structure 110 may intersect each other. For example, the grid element 130a may intersect the grid element 140a. In addition, the grid element 130a may further intersect the grid elements 140b and 140c. Similarly, the grid element 130b may intersect the grid elements 140a, 140b, 140c and the grid element 130c may intersect the grid elements 140a, 140b, 140c, 140d. In other words, grid elements 130a, 130b, 130c, 130d of the first group of grid elements may intersect grid elements 140a, 140b, 140c, 140d of the second group of grid elements. In addition, grid elements 130a, 130b, 130c, 130d of the first group of grid elements do not intersect each other and grid elements 140a, 140b, 140c, 140d of the second group of grid elements do not intersect each other.

In some embodiments, a first grid element of the plurality of grid elements 130a, 130b, 130c, 130d, 140a, 140b, 140c, 140d may intersect a second grid element of the plurality of grid elements 130a, 130b, 130c, 130d, 140a, 140b, 140c, 140d essentially at a right angle, e.g., essentially perpendicularly. For example, the grid element 130b may intersect the grid element 140b essentially perpendicularly. Similarly, the grid element 130a may intersect the grid element 140a essentially perpendicularly. In some embodiments, the plurality of grid elements 130a, 130b, 130c, 130d, 140a, 140b, 140c, 140d may comprise intersecting grid elements wherein the grid elements do not intersect essentially perpendicularly. For example, the grid element 130a may not intersect the grid element 140b essentially perpendicularly.

In some embodiments, the grid elements 130a, 130b, 130c, 130d, 140a, 140b, 140c, 140d of the grid structure 110 may comprise a thickness. The thickness of the grid elements 130a, 130b, 130c, 130d, 140a, 140b, 140c, 140d may comprise a thickness with respect to a plane orthogonal to a direction in which the grid elements 130a, 130b, 130c, 130d, 140a, 140b, 140c, 140d propagate, e.g., a direction following the spiral form of the grid elements 130a, 130b, 130c, 130d, 140a, 140b, 140c, 140d.

In some embodiments, the cushioning element 100 may comprise a continuous portion 150. The continuous portion 150 of the cushioning element 100 may be located at a boundary 105 of the cushioning element 100. Specifically, the continuous portion 150 of the cushioning element 100 may essentially encompass the boundary 105 of the cushioning element 100. For example, an inner boundary 152 of the continuous portion 150 of the cushioning element 100, e.g., a boundary of the continuous portion 150 adjacent to the grid structure 110, may essentially follows the boundary 105 of the cushioning element 100 (e.g., the inner boundary 152 of the continuous portion 150 may have essentially the same shape as the boundary 105). In some embodiments, the grid structure 110 may emanate from the origin 120 and may propagate towards the inner boundary 152 of the continuous portion 150. For example, the grid structure 110 may terminate at the inner boundary 152 of the continuous portion 150. Specifically, each of the grid elements 130a, 130b, 130c, 130d, 140a, 140b, 140c, 140d may emanate from the origin 120 and/or the aperture 125 and terminate at the continuous portion 150 of the cushioning element 100, particularly at the inner boundary 152 of the continuous portion 150.

In some embodiments, the continuous portion 150 comprises a diameter d. The diameter d of the continuous portion 150 comprises a diameter measured with respect to a direction pointing from the boundary 105 of the cushioning element towards an interior of the cushioning element, e.g., the grid structure and/or the origin 120 of the grid structure 110. In particular, the diameter d of the continuous portion 150 may comprise a distance between the boundary 105 of the cushioning element 100 and the inner boundary 152 of the continuous portion 150. For example, the diameter d of the continuous portion may be in the range between 0.1 cm and 6 cm. In some embodiments, the diameter of the continuous portion 150 may be based on the side of the grid structure 110.

In some embodiments, the cushioning element 100 may comprise a sidewall 160. The sidewall 160 may be located at the boundary 105 of the cushioning element. Specifically, the sidewall 160 may emerge from the continuous portion 150 of the cushioning element 100. For example, the sidewall 160 may comprise a portion of the continuous portion 150 that bends upwards, e.g., out of the plane shown in FIG. 1 (for example, out of the page toward the reader). In some embodiments, the sidewall 160 may be arranged at a lateral side 102c of the cushioning element and at a medial side 102a of the cushioning element 100. In other words, the sidewall 160 may not be arranged at a front portion (e.g., a toe end) of the cushioning element 100. In some embodiments, the sidewall 160 may not be arranged at a rear portion (e.g, an end opposite the toe end) of the cushioning element 100. Specifically, the sidewall 160 may be arranged in regions of the cushioning element 100 adapted to be located in a vicinity of a boundary of the sole plate. For example, the sidewall 160 may be arranged in regions of the cushioning element 100 adapted to contact a boundary of the sole plate. In some embodiments, the sidewall 160 may essentially encompass the complete boundary 105 of the cushioning element 100.

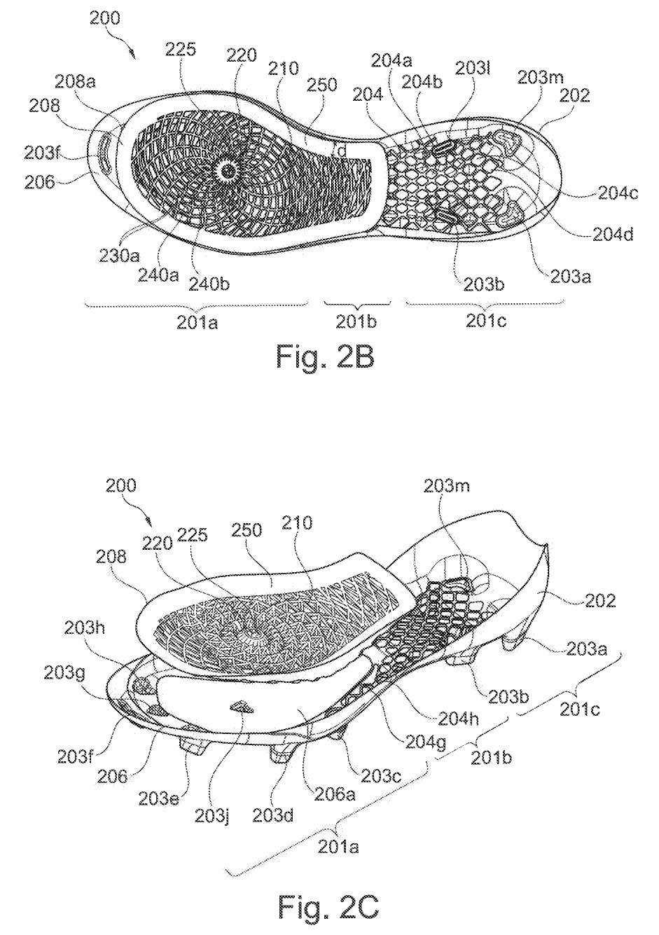

FIGS. 2A to 2D show a schematic exemplary embodiment of a system 200 comprising a sole plate 202 and a cushioning element 208. In some embodiments, the cushioning element 208 may comprise a grid structure 210. In some embodiments, the grid structure 210 of the cushioning element 208 may be arranged in a spiral pattern. In addition, the cushioning element 208 may comprise an origin 220. In particular, the origin 220 may comprise an aperture 225. In some embodiments, the aperture 225 may comprise a circle geometry. In some embodiments, a part of the grid structure 210 may emanate in the spiral pattern from the origin 220, particularly from the aperture 225. In some embodiments, the origin 220, particularly the aperture 225, may be arranged in a forefoot region 201a of the cushioning element 208 adapted to receive a forefoot. Specifically, the origin 220 may be located in a center portion of the forefoot region 201a.

In some embodiments, the grid structure 210 of the cushioning element 208 may comprise a plurality of grid elements that comprises at least grid elements 230a, 230b, 240a, 240b. In some embodiments, the grid elements 230a, 230b, 240a, 240b of the grid structure 210 may be arranged such as to form the spiral pattern of the grid structure 210. Specifically, a part of the plurality of grid elements 230a, 230b, 240a, 240b may emanate from the origin 220, particularly the aperture 225. For example, the grid elements 230a, 230b, 240a, 240b may emanate from the origin 220 of the grid structure 210. In some embodiments, a part of the grid elements of the grid structure 210 may not emanate from the origin 220. For example, grid elements located in a midfoot region 201b of the cushioning element may not emanate from the origin 220. In some embodiments, the plurality of grid elements 230a, 230b, 240a, 240b may comprise a first group of grid elements comprising the grid elements 230a, 230b, and a second group of grid elements comprising the grid elements 240a, 240b. In some embodiments, the grid elements 230a, 230b of the first group may be arranged such as to follow the spiral pattern in a clockwise orientation. For example, the grid elements 230a, 230b may emanate from the origin 220 such as to follow the spiral patter in a clockwise orientation. Similarly, the grid elements 240a, 240b of the second group may be arranged such as to follow the spiral pattern in a counterclockwise orientation. For example, the grid elements 240a, 240b may emanate from the origin 220 such as to follow the spiral patter in a counterclockwise orientation.

In some embodiments, as best seen in FIG. 2B and FIG. 2D, the sole plate 202 may comprise a second grid structure 204. The second grid structure 204 may be arranged in a heel region 201c of the sole plate 202 adapted to receive a rear and/or heel portion of a foot. In addition or alternatively, the second grid structure 204 may be arranged in a midfoot region 201b of the sole plate 202 adapted to receive a midfoot. In particular, the second grid structure 204 may extend from the heel region 201c of the sole plate 202 adapted to receive a rear and/or heel portion of a foot towards the midfoot region 201b of the sole plate 202 adapted to receive a midfoot. Specifically, the second grid structure 204 may split into two sub-parts in the midfoot region 201b. In other words, the part of the second grid structure 204 arranged in the rearfoot and/or heel region 201c may be formed as a connected grid structure and a part of the second grid structure 204 arranged in the midfoot region 201b may be divided into two sub-parts. A first sub-part of the second grid structure 204 may be arranged at a medial region of the sole plate 202 and a second sub-part of the second grid structure 204 may be arranged at a lateral region of the sole plate 202. For example, a length of the first and/or second sub-part of the second grid structure 204 may be at least 1 cm, at least 1.5 cm, at least 2 cm, at least 2.5 cm, or at least 3 cm. In addition, a width of the first and/or second sub-part of the second grid structure 204 may be at least 0.25 cm, at least 0.5 cm, at least 0.75 cm, at least 1 cm, or at least 1.25 cm. In some embodiments, a distance between the first sub-part of the second grid structure 204 and the second sub-part of the second grid structure 204 may increase towards a forefoot region 201a of the sole plate 202. Specifically, the distance between the first sub-part and the second sub-part may increase continuously along a direction pointing from the midfoot region 201b towards the forefoot region 201a. For example, a distance between the first sub-part and the second sub-part may be at least 0.25 cm, at least 0.5 cm, at least 0.75 cm, or at least 1 cm.

In some embodiments, the second grid structure 204 may comprise a linear and/or straight pattern. Specifically, the second grid structure 204 may comprises a plurality of grid elements arranged such as to essentially follow the linear and/or straight pattern. In other words, the grid elements of the plurality of grid elements may be essentially straight lines. For example, the grid elements of the second grid structure 204 may be arranged such as to form holes and/or notches 204a, 204b, 204c, 204d, 204e, 204f, 204g, 204h. In some embodiments, the holes and/or notches 204a, 204b, 204c, 204d, 204e, 204f, 204g, 204h may comprise a rectangular and/or rhombus shape. In some embodiments, the size of the holes and/or notches 204a, 204b, 204c, 204d, 204e, 204f, 204g, 204h may vary across the second grid structure 204. For example, holes and/or notches 204c, 204d arranged in a rearfoot and/or heel region 201c may be larger than holes and/or notches arranged in a midfoot region 201b. In some embodiments, the first sub-part of the second grid structure 204, e.g., the medial sub-part, may comprise the holes and/or notches 204e, 204f. In some embodiments, the second sub-part of the grid structure 204, e.g., the lateral sub-part, may comprise the holes and/or notches 204g, 204h.

In some embodiments, the sole plate 202 may comprise a cavity 206 adapted to receive the cushioning element 208. In some embodiments, the cavity 206 may formed integrally with the sole plate 202. For example, the sole plate 202 may be formed such that a portion of the sole plate 202 essentially forms the cavity 206. In some embodiments, the cavity 206 may have a size and/or shape configured to receive the cushioning element 208. For example, the cavity 206 and the cushioning element 208 may have similar sizes and/or shapes such that the cavity 206 and the cushioning element 208 have a locking engagement (e.g., the cushioning element 208 may be locked to the cavity 206 when the cushioning element 208 is arranged at the cavity 206). In some embodiments, the cavity 206 may be arranged in the forefoot region 201a of the sole plate 202. In some embodiments, the cavity 206 may be arranged in the midfoot region 201b of the sole plate 202. In some embodiments, the cavity 206 may be arranged in the forefoot region 201a and the midfoot region 201b. For example, the cavity 106 may extend from the forefoot region 201a to the midfoot region 201b. In some embodiments, the cavity 106 may be arranged on the foot-facing side of the sole plate 202. More specifically, the cavity 106 may be arranged on a side of the sole plate 202 adapted to face the foot of the athlete (e.g., opposite a ground facing surface of the sole plate 202).

In some embodiments, a size and/or shape of the cavity 106 may be based on a size and/or shape of the sole plate 202. For example, a diameter of the cavity 106 may be based on a diameter of the sole plate 202. In embodiments in which the cavity 106 and/or the sole plate 202 may not have a circular shape, a dimension of the cavity 106 may be based on a dimension of the sole plate 202.

In some embodiments, the cavity 206 may comprise a central region 206a. In some embodiments, the central region 206a may be located underneath the grid structure 210. For example, the central region 206a may comprise a size and/or shape that corresponds to the size and/or shape of the grid structure 210.

As best seen in FIG. 2D, the sole plate 202 may comprise a plurality of studs 203a-203m. In some embodiments, the plurality of studs 203a-203m may extend and/or protrude from an outer surface of the sole plate 202. In some embodiments, the studs 203a, 203b, 203l, 203m may be arranged in a rearfoot and/or heel region 201c of the sole plate 202, e.g., a portion of the sole plate adapted to receive a rearfoot and/or a heel. In some embodiments, the studs 203a, 203b may be arranged at a lateral side of the sole plate 202 and the studs 203l, 203m may be arranged at a medial side of the sole plate 202. In addition, the sole plate 202 may comprise studs 203c, 203k which may be arranged at a transition region between a midfoot region 201b of the sole plate 202 and a forefoot region 201a of the sole plate 202. In some embodiments, the stud 203c may be arranged at a lateral side and the stud 203k may be arranged at a medial side of the sole plate 202. In addition, the sole plate 202 may comprise the studs 203d, 203e, 203f, 203g, 203h, 203i, 203j which may be arranged in the forefoot region 201a of the sole plate 202. Specifically, the studs 203d and 203e may be arranged at a lateral side of the sole plate 202 and the studs 203h and 203i may be arranged at a medial side of the sole plate 202. In addition, the studs 203f, 203g and 203j may be arranged at a center portion of the sole plate 202, e.g., a region of the sole plate 202 where the medial portion transitions into the lateral portion.

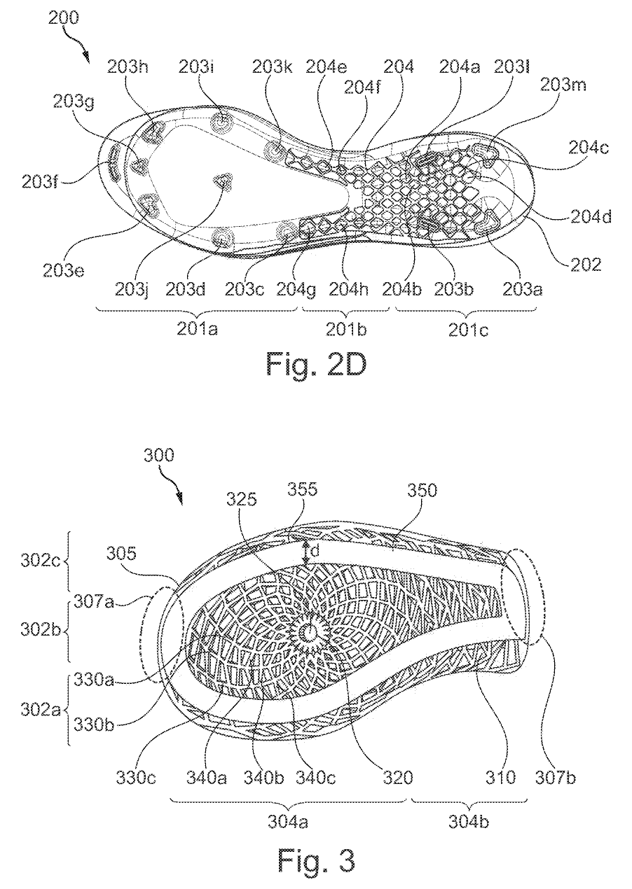

FIG. 3 shows a schematic exemplary embodiment of a cushioning element 300. In some embodiments, the cushioning element 300 may be adapted to be arranged at a sole plate of a shoe. In some embodiments, the cushioning element 300 may comprise a grid structure 310. The grid structure 310 may be arranged in a spiral pattern. In some embodiments, the grid structure 310 of the cushioning element 300 may emanate in the spiral pattern from an origin 320. In some embodiments, the origin 320 of the grid structure 310 may comprises an aperture 325. In some embodiments, the aperture 325 of the origin 320 may comprise a circle geometry. The origin 320, particularly the aperture 325 of the origin, may be located in a center portion 320b of a region 304a adapted to receive a forefoot.

In some embodiments, the grid structure 310 of the cushioning element 300 may comprise a plurality of grid elements 330a, 330b, 330c, 340a, 340b, 340c. In some embodiments, the grid elements 330a, 330b, 330c, 340a, 340b, 340c may be arranged such as to form the spiral pattern of the grid structure 310. In particular, at least a subset of the plurality of grid elements 330a, 330b, 330c, 340a, 340b, 340c may emanate from the origin 320 of the grid structure 310. For example, the at least the subset of the plurality of grid elements 330a, 330b, 330c, 340a, 340b, 340c may emanate from the aperture 325 of the origin 320. Specifically, the at least the subset of the plurality of grid elements 330a, 330b, 330c, 340a, 340b, 340c may emanate from the origin 320 and/or the aperture 325 such as to follow a spiral.

In some embodiments, the plurality of grid elements 330a, 330b, 330c, 340a, 340b, 340c may comprise a first set of grid elements (e.g., the grid elements 330a, 330b, 330c) and a second set of grid elements (e.g., the grid elements 340a, 340b, 340c). In some embodiments, the grid elements 330a, 330b, 330c of the first group may be arranged such as to emanate and/or propagate in a clockwise orientation. In some embodiments, the grid elements 340a, 340b, 340c of the second group may be arranged such as to emanate and/or propagate in a counterclockwise orientation. In some embodiments, the first set of grid elements may intersect the second set of grid elements. For example, the grid element 330a of the first group of grid elements may intersect the grid element 340a, 340b, 340c of the second group of grid elements. In particular, the grid element 330a may intersects the grid element 340a essentially perpendicularly.

In some embodiments, the cushioning element 300 may further comprise a continuous portion 350. In some embodiments, at least a part of the continuous portion 350 may be located at a boundary 305 of the cushioning element 300. Specifically, the continuous portion 350 may be located at the boundary 305 of the cushioning element 300 in a front portion 307a (e.g., a toe portion) and/or in a rear portion 307b (e.g., a portion located opposite the toe portion). For example, a boundary 355 of the continuous portion 350 may be located in a vicinity of the boundary 305 of the cushioning element 300 in the front portion 307a and/or in the rear portion 307b. Specifically, in the front portion 307a, the boundary 355 of the continuous portion 350 may contact and/or transition into the boundary 305 of the cushioning element 300. In some embodiments, the continuous portion 350, particularly the boundary 355 of the continuous portion 350, may be arranged such that the boundary 355 of the continuous portion 350 and the boundary 305 of the cushioning element 300 may be separated, e.g., separated by a distance. In some embodiments, the boundary 355 of the continuous portion 350 and the boundary 305 of the cushioning element may be distant at a lateral region 302c and medial region 302a of the cushioning element 300. In some embodiments, the boundary 355 of the continuous portion 350 and the boundary 305 of the cushioning element 300 may be distant such that a portion of the grid structure 310 extends between the boundary 355 of the continuous portion 350 and the boundary 305 of the cushioning element 300.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

The examples are illustrative, but not limiting, of the present disclosure. Other suitable modifications and adaptations of the variety of conditions and parameters normally encountered in the field, and which would be apparent to those skilled in the art, are within the spirit and scope of the present disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A cushioning element adapted to be arranged at a sole plate of a shoe, comprising a grid structure, wherein the grid structure is arranged in a spiral pattern.

2. The cushioning element according to claim 1, wherein at least a part of the grid structure emanates in the spiral pattern from an origin of the grid structure.

3. The cushioning element according to claim 2, wherein the origin comprises an aperture, and wherein the aperture comprises a circular or elliptic geometry.

4. The cushioning element according to claim 3, wherein the origin of the grid structure is arranged in a forefoot region of the cushioning element and is:
adapted to receive a medial portion of a foot; and/or
adapted to receive a central portion of a foot.

5. The cushioning element according to claim 2, wherein the grid structure comprises a plurality of grid elements, wherein the plurality of grid elements is arranged such as to at least partially form the spiral pattern of the grid structure.

6. The cushioning element according to claim 5, wherein at least one grid element of the plurality of grid elements emanates from the origin of the grid structure.

7. The cushioning element according to claim 5, wherein a first grid element of the plurality of grid elements intersects at least a second grid element of the plurality of grid elements.

8. The cushioning element according to claim 7, wherein the first grid element intersects the second grid element essentially perpendicularly.

9. The cushioning element according to one claim 1, further comprising a continuous portion, wherein at least a part of the continuous portion is located at a boundary of the cushioning element.

10. The cushioning element according to claim 1, wherein a shape and/or size of the cushioning element is based on a shape and/or size of a portion of the sole plate.

11. The cushioning element according to claim 1, wherein the grid structure covers:
at least 10% of the cushioning element; and
at most 99% of the cushioning element.

12. The cushioning element according to claim 9, further comprising at least one sidewall, wherein the at least one sidewall is arranged at a boundary of the cushioning element and extends from the continuous portion of the cushioning element.

13. A sole plate adapted to be arranged at a shoe, the sole plate comprising:
a first cavity adapted to receive a first cushioning element according to claim 1.

14. The sole plate according to claim 13, wherein the first cavity is arranged in a region of the sole plate adapted to receive a forefoot and/or a midfoot and extends from the region adapted to receive the forefoot to the region adapted to receive the midfoot.

15. The sole plate according to claim 14, wherein a diameter of the first cavity is based on a diameter of the sole plate.

16. The sole plate according to claim 13, wherein the first cavity is arranged on a side of the sole plate adapted to face a foot.

17. The sole plate according to claim 13, wherein the sole plate comprises a second grid structure; and wherein the second grid structure comprises a spiral and/or rectangular pattern.

18. The sole plate according to claim 17, wherein the second grid structure is arranged at a heel area of the sole plate.

19. The sole plate according to claim 17, wherein:
at least a portion of the second grid structure is integrally formed with the sole plate.

20. A shoe, comprising:
a sole plate according to claim 19; and
a cushioning element according to claim 1;
wherein the cushioning element is arranged in a cavity of the sole plate.
